(19) United States
(12) Patent Application Publication
(10) Pub. No.: US 2017/0011417 A1
(43) Pub. Date: Jan. 12, 2017

(54) ADVERTISEMENT BASED CACHING PROCESSING SYSTEM, METHOD THEREFOR, AND APPARATUS APPLIED THERETO

(71) Applicant: SK PLANET CO., LTD., Seongnam-si (KR)

(72) Inventor: Min Ho HAN, Seoul (KR)

(21) Appl. No.: 15/116,212

(22) PCT Filed: Dec. 1, 2014
(86) PCT No.: PCT/KR2014/011611

§ 371 Date: Aug. 3, 2016

(30) Foreign Application Priority Data
Feb. 12, 2014 (KR) 10-2014-0015945

(51) Int. Cl. G06Q 30/02

(52) U.S. Cl. CPC G06Q 30/0241

(57) ABSTRACT

Disclosed are an advertisement based caching processing system, a method therefor, and an apparatus applied thereto. That is, according to the present invention, at least part of all advertisement reception agreement information to be identified when advertisement is provided is determined as information to be compressed so that only the advertisement reception agreement information determined as the information to be compressed is allowed to be identified in a compressed state, thereby minimizing an access to a database for identifying the advertisement reception agreement information.

### TECHNICAL FIELD

The present invention relates to a method for determining at least part of advertisement reception agreement information, which is required to be identified for providing advertisement, as information to be compressed so that the advertisement reception agreement information determined as the information to be compressed is allowed to be identified in a compressed state.

### BACKGROUND ART

An advertisement platform (hereinafter, referred to as ‘advertisement platform apparatus’) having large traffic holds more than ten million advertisement reception assenters.

Most of the advertisement platform apparatuses identify advertisement reception agreement information for checking whether an advertisement requester is authorized to receive advertisement, when the advertisement platform apparatuses receive an advertisement request.

For this reason, the advertisement platform apparatuses frequently access a database in which the advertisement reception agreement information is stored, such that the database cannot afford to excessive traffic, thereby increasing the occurrence risk of disorders.

Therefore, a new method for solving the occurrence risk of disorders in the database when the advertisement platform apparatus identifies the advertisement reception agreement information will be required.

### DISCLOSURE

### Technical Problem

An object of the present invention is to determine at least part of all advertisement reception agreement information required to be identified for providing advertisement as information to be compressed so that the advertisement reception agreement information determined as the information to be compressed is allowed to be identified in a compressed state, thereby minimizing an access to a database for identifying the advertisement reception agreement information.

### Technical Solution

A cashing processing apparatus according to first embodiment of the present invention to accomplish the above object comprises: an extraction unit configured to extract advertisement reception agreement information from a database, advertisement reception agreement information being required to be identified from an advertising platform apparatus; a determination unit configured to determine at least part of all the advertisement reception agreement information extracted from the database as information to be compressed; and a compression unit configured to compress the advertisement reception agreement information determined as the information to be compressed to allow the advertising platform apparatus to identify the compressed advertising reception agreement information in a compressed state.

The information to be compressed is determined on the basis of all the information identification count obtained by summing information identification count for each of all the advertising reception agreement information. The determination unit accumulates and sums the information identification count in a rank of the most information identification count all the advertising reception agreement information and determine the rest advertising reception agreement information of which the information identification count is not summed among all the advertising reception agreement information as the information to be compressed when the accumulated and summed information identification count reaches a set ratio for all the information identification count.

The information to be compressed is determined on the basis of the number of all the advertising reception agreement information. The determination unit excludes the advertising reception agreement information in the rank of the most information identification count and determines the rest advertising reception agreement information which is not excluded from all the advertising reception agreement information as the information to be compressed when the number of excluded advertising reception agreement information reaches the number of all the advertising reception agreement information as much as the set ratio.

The information to be compressed is determined on the basis of whether a set-up time from timing when the advertisement reception agreement information is first extracted from the database elapses. The determination unit determines all the advertising reception agreement information as the information to be compressed when the set time from timing when the advertising reception agreement information is first extracted from the database does not elapse and determines only part of all the advertising reception information as the information to be compressed when the set time from timing when the advertising reception agreement information is first extracted from the database elapses.

An advertising based cashing processing method according to second embodiment of the present invention to accomplish the above object comprises extracting, by a cashing processing apparatus, advertisement reception agreement information from a database, advertisement reception agreement information being required to be identified from an advertising platform apparatus; sorting, by the cashing processing apparatus, at least part of all the advertisement reception agreement information extracted from the database as information to be compressed; compressing, by the cashing processing apparatus, the advertising reception agreement information determined as the information to be compressed; and identifying, by the advertising platform apparatus, the compressed advertising reception agreement information in a compressed state.

A method for operating a cashing processing apparatus according to third embodiment of the present invention to accomplish the above object comprises: extracting advertisement reception agreement information a database, advertisement reception agreement information being required to be identified from an advertising platform apparatus; determining at least part of all the advertisement reception agreement information extracted from the database as information to be compressed; and compressing the advertisement reception agreement information determined as the information to be compressed to allow the advertising platform apparatus to identify the compressed advertising reception agreement information in a compressed state.

The information to be compressed is determined on the basis of all the information identification count obtained by summing information identification count for each of all the advertising reception agreement information. The determining comprises: accumulating and summing the information identification count in a rank of the most information identification count all the advertising reception agreement information and determining the rest advertising reception agreement information of which the information identification count is not summed among all the advertising reception agreement information as the information to be compressed when the accumulated and summed information identification count reaches a set ratio for all the information identification count.

The information to be compressed is determined on the basis of the number of all the advertising reception agreement information. The determining comprises: excluding the advertising reception agreement information in the rank of the most information identification count and determining the rest advertising reception agreement information which is not excluded from all the advertising reception agreement information as the information to be compressed when the number of excluded advertising reception agreement information reaches the number of all the advertising reception agreement information as much as the set ratio.

The information to be compressed is determined on the basis of whether a set-up time from timing when the advertisement reception agreement information is first extracted from the database elapses. The determining comprises: determining all the advertising reception agreement information as the information to be compressed when the set time from timing when the advertising reception agreement information is first extracted from the database does not elapse and determining only part of all the advertising reception information as the information to be compressed when the set time from timing when the advertising reception agreement information is first extracted from the database elapses.

### Advantageous Effects

According to the advertisement based caching processing system, the method therefor, and the apparatus applied thereto in accordance with the present invention, at least part of the whole advertisement reception agreement information required to be identified for providing advertisement is determined as the information to be compressed so that the advertisement reception agreement information determined as the information to be compressed is allowed to be identified in the compressed state, thereby minimizing the access to the database for identifying the advertisement reception agreement information.

### DESCRIPTION OF DRAWINGS

FIG. 1 is a schematic configuration diagram of an advertisement based cashing processing system according to an embodiment of the present invention.

FIG. 2 is a schematic configuration diagram of a log management apparatus according to an embodiment of the present invention.

FIG. 3 is a diagram for describing a log data structure according to an embodiment of the present invention.

FIG. 4 is a schematic flow chart for describing an operation flow of the advertisement based cashing processing system according to the embodiment of the present invention.

FIG. 5 is a schematic flow chart for describing an operation process of an advertisement platform apparatus according to an embodiment of the present invention.

### BEST MODE

Hereinafter, one embodiment of the present invention will be described with reference to the accompanying drawings.

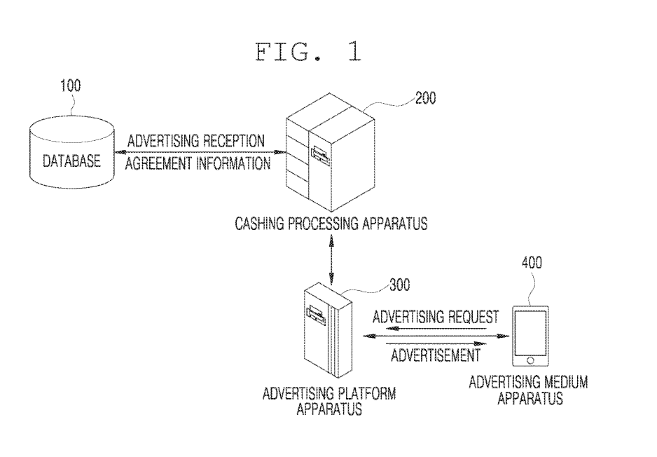

FIG. 1 is a diagram illustrating an advertisement based cashing processing system according to an embodiment of the present invention.

As illustrated in FIG. 1, the advertisement based cashing processing system according to the embodiment of the present invention is configured to include a database 100 storing advertisement reception agreement information, a cashing processing apparatus 200 extracting and storing the advertisement reception agreement information from the database 100 and allowing an advertisement platform apparatus 300 to identify the advertisement reception agreement information extracted from the database 100, an advertisement platform apparatus 300 allowing the advertisement medium apparatus 400 to provide advertisement according to a request after the advertisement reception agreement information is identified, and the advertisement medium apparatus 400 requesting advertisement to the advertisement platform apparatus 300 and receiving the advertisement therefrom.

The database 100 is called a kind of memory server collecting and storing the advertisement reception agreement information which is information for checking whether an advertisement requester requesting advertisement through the advertisement medium apparatus 400 substantially agrees the reception of the advertisement.

The cashing processing apparatus 200 applies a cashing processing technique and is called a server which extracts and stores the advertisement reception agreement information stored in the database 100 and allows the advertisement platform apparatus 300 to identify the stored advertisement reception agreement information.

Here, the cashing processing technique performed by the cashing processing apparatus 200 is a scheme of extracting and storing the corresponding advertisement reception agreement information from the database 100 when the advertisement reception agreement information receiving a identification request from the advertisement platform apparatus 300 is not stored and then identifying the advertisement reception agreement information stored in its own memory space without accessing the database 100 when the identification of the same advertisement reception agreement information is requested.

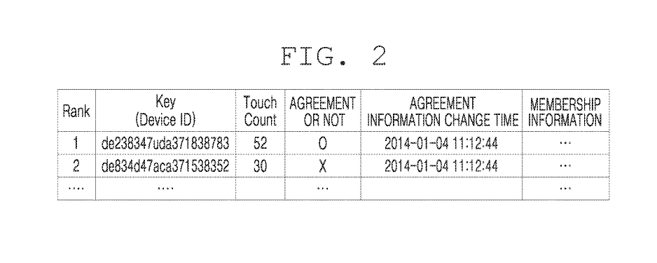

Further, as described above, the advertisement reception agreement information is called information for checking whether the advertisement requester substantially agrees the advertisement reception. For example, as illustrated in FIG. 2, the advertisement reception agreement information may be managed in a hash table form to guarantee a fast identification speed.

Here, the advertisement reception agreement information may include an information identification count which is a count identified by the advertisement platform apparatus 300, sharing identification information KEY of the advertisement medium apparatus requesting advertisement, whether or not advertisement reception agrees, agreement information change time which is time when the agreement or not is changed or a set-up time, membership information (for example, age, taste, residential area, interest) required for advertisement targeting, and a rank according to the information identification count.

The advertisement platform apparatus 300 refers to an advertisement server for providing advertisement to an advertisement medium which is being executed by the advertisement medium apparatus 400 or which the advertisement medium apparatus 400 accesses.

The advertisement platform apparatus 300 provides advertisement by a pull scheme of storing advertisement from an advertiser and providing the advertisement according to the advertisement request received from the advertisement medium apparatus 400.

As such, the advertisement platform apparatus 300 checks whether the advertisement requester agrees the advertisement reception when the advertisement is requested from the advertisement medium apparatus 400.

To this end, the advertisement platform apparatus 300 identifies the advertisement reception agreement information stored in the cashing processing apparatus 200 and provides the advertisement to the advertisement medium apparatus 400 only when the reception agreement is checked.

For reference, the advertisement platform apparatus 300 may provide advertisement even by a push scheme of providing advertisement to the advertisement medium apparatus 400 independent of the advertisement request as well as the pull scheme.

The advertisement medium apparatus 400 is called a device for executing an application which is the advertisement medium or accessing a web page.

For example, the advertisement medium apparatus 400 may correspond to a smart phone, a tablet PC, a PDC, etc., but is not limited thereto. Therefore, the advertisement medium apparatus 400 may include devices which may execute the application App operated as the advertisement medium or access the web page Web which is another type of advertisement medium.

Therefore, the advertisement medium apparatus 400 may be classified into an application type advertisement medium apparatus which executes the application as the advertisement medium and a web type advertisement medium apparatus accessing the web page which is the advertisement medium.

Meanwhile, according to the embodiment of the present invention, the cashing processing apparatus 200 extracts the advertisement reception agreement information stored in the database 100 using the cashing processing technique and stores the extracted advertisement reception agreement information in its own memory space, such that the advertisement platform apparatus 300 may identify the advertisement reception agreement information.

In this case, due to a limit of the memory space, the cashing processing apparatus 200 generally an expired time which is time when the advertisement reception agreement information may be stored.

That is, the cashing processing apparatus 200 holds the storage state of the advertisement reception agreement information extracted from the database 100 only for the expired time and deletes the corresponding advertisement reception agreement information from the memory space when the expired time elapses.

However, due to similarity of an advertisement use pattern (for example: advertisement request time slot), the expired time of a large amount of advertisement reception agreement information may elapse at the same time. In this case, the cashing processing apparatus 200 needs to delete the large amount of advertisement reception agreement information from its own memory space at the same timing.

As such, deleting the large amount of advertisement reception agreement information means re-accessing the database 100 as much as the amount of deleted advertisement reception agreement information.

By doing so, to extract the deleted advertisement reception agreement information from the database 100, large traffic occurs due to the frequently re-accessed cashing processing apparatus 200, which may lead to the reduction in performance of the database 100.

Therefore, according to the embodiment of the present invention, a method for effectively managing advertisement reception agreement information if possible without applying the foregoing expired time to the advertisement reception agreement information stored in the cashing processing apparatus 200, which will be described below in detail.

Meanwhile, the embodiment of the present invention will be described under the precondition that the advertisement reception agreement information executed by the cashing processing apparatus 200 is extracted from the database 100, and a series of operations which may be identified are performed at each period in one unit.

First, the cashing processing apparatus 200 serves to extract the advertisement reception agreement information.

In more detail, the cashing processing apparatus 200 extracts the advertisement reception agreement information stored in the database 100 and stores the extracted advertisement reception information in its own memory space.

In this case, the cashing processing apparatus 200 may extract and store the advertisement reception agreement information stored in the database 100 in a lump at each period (for example: day unit) or individually extract and store the advertisement reception agreement information requested to be identified from the advertisement platform apparatus 300 from the database 100 regardless of the period.

Further, the cashing processing apparatus 200 serves to determine the information to be compressed.

In more detail, the cashing processing apparatus 200 determines all the advertisement reception agreement information extracted from the database 100 as the information to be compressed when the advertisement reception agreement information does not pass a set-up time (for example: four hours) from the first extracted timing since it means that the information identification count is not sufficiently accumulated and updated.

On the other hand, the cashing processing apparatus 200 chooses only part of the advertisement reception agreement information extracted from the database 100 and determines the chosen advertisement reception agreement information as the information to be compressed when the advertisement reception agreement information passes a set-up time (for example: four hours) from the first extracted timing since it means that the information identification count is sufficiently accumulated and updated.

In this case, when only some of all the advertisement reception agreement information is determined as the information to be compressed, the cashing processing apparatus 200 determines the information to be compressed on the basis of the information identification count of all of the advertisement reception agreement information, respectively.

That is, the cashing processing apparatus 200 accumulates and sums the information identification count for each of the advertisement reception agreement information in a rank of the most information identification count and when the accumulated and summed information identification count reaches a set ratio compared to all the information identification count, determines the rest advertisement reception agreement information of which information identification count are not summed among all the advertisement reception agreement information as the information to be compressed.

Further, the cashing processing apparatus 200 serves to compress the advertisement reception agreement information determined as the information to be compressed.

In more detail, the cashing processing apparatus 200 may compress the advertisement reception agreement information determined as the information to be compressed among all the advertisement agreement information extracted and stored from the database 100 so that the advertisement platform apparatus may identify the compressed advertisement reception agreement information and the rest advertisement reception agreement information which is not compressed.

In this case, in compressing the advertisement reception agreement information, the cashing processing apparatus 200 compresses only ‘membership information’ requiring a storage space larger than that required for other information among the information included in the advertisement reception agreement information.

Further, the cashing processing apparatus 200 serves to identify the advertisement reception agreement information.

In more detail, when the identification of the advertisement reception agreement information is requested from the advertisement platform apparatus 300 receiving the advertising request from the advertisement medium apparatus 400, the cashing processing apparatus 200 extracts the corresponding advertisement reception agreement information stored in the memory space and transmits the extracted advertisement reception agreement information to the advertisement medium apparatus 400.

In this case, if it is checked that the advertisement reception does not agree (x) on the basis for the ‘agreement or not’ included in the corresponding advertisement reception agreement information, the casing processing apparatus 200 notifies the corresponding advertisement platform apparatus 300 of the checked information so that the advertisement platform apparatus 300 does not provide advertisement to the advertisement medium apparatus 100.

On the other hand, if it is checked that the advertisement reception agrees (o) on the basis of the ‘agreement or not’ included in the corresponding advertisement reception information, the cashing processing apparatus 200 once accumulates the information identification count and updates the accumulated information identification count.

Here, when it is identified the corresponding advertisement reception agreement information is compressed after the information identification count is accumulated and updated, the casing processing apparatus 200 decompresses the compressed advertisement reception agreement information and transmits the decompressed advertisement reception agreement information to the advertisement platform apparatus 300, so that the advertisement platform apparatus 300 provides advertisement to the advertisement medium apparatus 100.

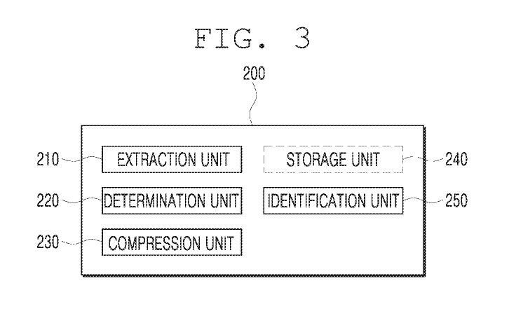

Hereinafter, the configuration of the casing processing apparatus 200 according to the embodiment of the present invention will be described in more detail with reference to FIG. 3.

That is, the cashing processing apparatus 200 according to the embodiment of the present invention is configured to include an extraction unit 210 extracting the advertisement reception agreement information from the database 100, a determination unit 220 determining the information to be compressed among all the advertisement reception agreement information extracted from the database 100, a compression unit 230 compressing the advertisement reception agreement information determined as the information to be compressed, and a storage unit 240 which is the memory space in which the extracted advertisement reception agreement information is stored, and a identification unit 250 identifying the stored advertisement reception agreement information.

Here, at least part or all of the configuration of the extraction unit 210, the determination unit 220, the storage unit 240, and the identification unit 250 as described above included in the cashing processing apparatus 200 may be implemented in a software module form executed by a processor or may be implemented by a combination of the software module and hardware.

First, the extraction unit 210 serves to extract the advertisement reception agreement information.

In more detail, the extraction unit 210 extracts the advertisement reception agreement information stored in the database 100 and stores the extracted advertisement reception information in the storage unit 240 which is its own memory space.

In this case, the extraction unit 210 may extract and store the advertisement reception agreement information stored in the database 100 at each period (for example: day unit) or individually extract and store the advertisement reception agreement information from the database 100 regardless of the period.

Here, when the advertisement reception agreement information requested to be identified from the advertisement platform apparatus 300 is present in its own memory space in advance, there is no need to extract the advertisement reception agreement information from the database 100.

Further, the determination unit 220 serves to determine the information to be compressed.

In more detail, the determination unit 220 determines at least part of all advertisement reception agreement information extracted from the database 100 as the information to be compressed.

As such, determining at least part of all advertisement reception agreement information extracted from the database 100 as the information to be compressed is to optimize the performance of the cashing processing apparatus 200 by maximizing the utilization of the memory space management.

In this case, to determine the information to be compressed, the determination unit 220 checks whether a set-up time (for example: four hours) from the time when the advertisement reception agreement information is first extracted from the database 100, that is, a start time of a current period elapses.

As such, checking whether the set-up time (for example: four hours) from the start time of the current period elapses or not is to check whether the information identification count of the advertisement reception agreement information which is an important parameter for determining the information to be compressed is sufficiently accumulated and updated or not.

Therefore, the determination unit 220 determines all the advertisement reception agreement information extracted from the database 100 as the information to be compressed when the advertisement reception agreement information does not pass a set-up time (for example: four hours) from the first extracted timing since it means that the information identification count is not sufficiently accumulated and updated.

On the other hand, the determination unit 220 chooses only some of the advertisement reception agreement information extracted from the database 100 and determines the chosen advertisement reception agreement information as the information to be compressed when the advertisement reception agreement information passes a set-up time (for example: four hours) from the first extracted timing since it means that the information identification count is sufficiently accumulated and updated.

Here, when only some of all the advertisement reception agreement information is determined as the information to be compressed, the cashing processing apparatus 200 determines the information to be compressed on the basis of the information identification count of all of the advertisement reception agreement information, respectively.

That is, the determination unit 220 accumulates and sums the information identification count of the advertisement reception agreement information in a rank of the most information identification count and when the accumulated and summed information identification count reaches a set ratio compared to all the information identification count, determines the rest advertisement reception agreement information of which the information identification count are not summed among all the advertisement reception agreement information as the information to be compressed.

Here, the increase in the information identification count means that the identification request from the advertisement platform apparatus 300 is frequent as many, but to the contrary, the reduction in the information identification count means that the identification request from the advertisement platform apparatus 300 is not performed frequently.

Therefore, the determination unit 220 determines the advertising reception agreement information with the small information identification count as the information to be compressed to obtain the memory space. In addition the determination unit 220 maintains the advertising reception agreement information with the large information identification count to be in the non-compressed state, such that the identification may be performed without the separate decompression procedure.

For example, when the set ratio is 80%, the information identification count of the advertising reception agreement information is accumulated and summed in the rank of the most information identification count and when the accumulated and summed information identification count reaches 80% compared to all the information identification count, the advertising reception agreement information of the remaining 20% of which the most information identification count is not accumulated and summed may be determined as the information to be compressed.

This means that the advertising reception agreement information of the rank of upper 20% generates traffic of 80% and the advertising reception agreement information of the upper 20% needs to be maintained in the non-compressed state so that the decompression of the advertising reception agreement information is not performed.

Here, the rank of the advertising reception agreement information corresponding to the timing when the accumulated and summed information identification count reaches 80% compared to all the information identification count may be defined as a base rank and the advertising reception agreement information having the following rank may be determined as the information to be compressed on the basis of the base rank.

Meanwhile, the information to be compressed may be determined on the basis of the number of all the advertising reception agreement information, that is, the number of users determining whether the advertising reception agrees.

That is, the determination unit 220 excludes the advertising reception agreement information in the rank of the most information identification count and determines the rest advertising reception agreement information which is not excluded from all the advertising reception agreement information as the information to be compressed when the number of excluded advertising reception agreement information reaches the number of all the advertising reception agreement information as much as the set ratio.

For example, when the set ratio is 80%, the advertising reception agreement information is excluded in the rank of the most information identification count and when the number of excluded advertising reception agreement information reaches 80% of all the advertising reception agreement information, the advertising reception agreement information of the rest 20% which is not excluded may be determined as the information to be compressed.

An operation of the determination unit 220 for determining the information to be compressed as described above may be repeated whenever the advertising reception agreement information is extracted from the database 100 or the advertising platform apparatus 300 identifies the advertising reception agreement information.

Here, extracting the advertising reception agreement information from the database 100 means that new advertising reception agreement information is stored in the cashing processing apparatus 200 and identifying the advertising reception agreement information by the advertising platform apparatus 300 means that the information identification count of the pre-stored advertising reception agreement information is accumulated and updated.

Therefore, the determination unit 220 repeats an operation for determining the information to be compressed whenever the above situation occurs to positively reflect the change state of the advertising reception agreement information such as newly storing the advertising reception agreement information or updating the information identification count of the advertising reception agreement information.

Further, the compression unit 230 serves to compress the advertisement reception agreement information determined as the information to be compressed.

In more detail, the compression unit 230 may compress the advertisement reception agreement information determined as the information to be compressed among all the advertisement agreement information extracted and stored from the database 100 so that the advertisement platform apparatus may identify with the rest advertisement reception agreement information which is not compressed.

In this case, in compressing the advertisement reception agreement information, the compression unit 230 compresses only ‘membership information’ requiring a storage space larger than that required for other information among the information included in the advertisement reception agreement information.

The rest information included in the advertising reception agreement information such as ‘rank’ depending on the information identification count, ‘information identification count’, ‘agreement or not’, and ‘agreement information change time’ is maintained in the non-compressed state since only the substantially small storage space is required.

In particular, as the information identification count is accumulated and updated whenever the advertising platform apparatus 300 identifies the advertisement reception agreement information, it is more efficient for the information identification count to be maintained in the non-compressed state so as not to repeat the compression and the decompression.

Further, the identification unit 250 serves to identify the advertisement reception agreement information.

In more detail, if the identification of the advertisement reception agreement information is requested from the advertisement platform apparatus 300 receiving the advertising request from the advertisement medium apparatus 400, the identification unit 250 extracts the corresponding advertisement reception agreement information stored in the memory space and transmits the extracted advertisement reception agreement information to the advertisement medium apparatus 400.

In this case, if it is checked that the advertisement reception does not agree (x) on the basis for the ‘agreement or not’ included in the corresponding advertisement reception agreement information, the identification unit 250 notifies the corresponding advertisement platform apparatus 300 of the checked information so that the advertisement platform apparatus 300 does not provide advertisement to the advertisement medium apparatus 100.

On the other hand, if it is checked that the advertisement reception agrees (o) on the basis of the ‘agreement or not’ included in the corresponding advertisement reception information, the identification unit 250 once accumulates the information identification count and updates the accumulated information identification count.

Further, when the information identification count is accumulated and updated and then the compressed state of the corresponding advertisement reception agreement information, the identification unit 250 transmits the information identification count to the advertisement platform apparatus 300 after the decompression, so that the advertisement platform apparatus 300 provides advertisement to the advertisement medium apparatus 100.

Meanwhile, the identification unit 250 allows the extraction unit 210 to extract the corresponding advertising reception agreement information from the database 100 only when the advertisement reception agreement information receiving the identification request from the advertising platform apparatus 300 is not stored to be able to transmit the extracted advertising reception agreement information to the advertising platform apparatus 300.

In this case, the advertisement reception agreement information extracted from the database 100 may preferentially update only the information identification count and then may be transmitted to the advertising platform apparatus 300 and may be reflected as a candidate for determining the information to be compressed after the transmission.

As described above, according to the advertising based cashing processing system in accordance with the embodiment of the present invention, to check whether the advertising requester may receive advertisement, the casing processing apparatus 200 is configured to compress at least part of all the advertising reception agreement information extracted from the database 100 to allow the advertising medium apparatus 300 to identify the advertising medium apparatus 300 to identify the advertising reception agreement information to thereby minimize the access to the database 10 depending on the identification of the advertising reception agreement information, thereby preventing disorders from occurring due to the excessive traffic depending on the frequent access to the database 100.

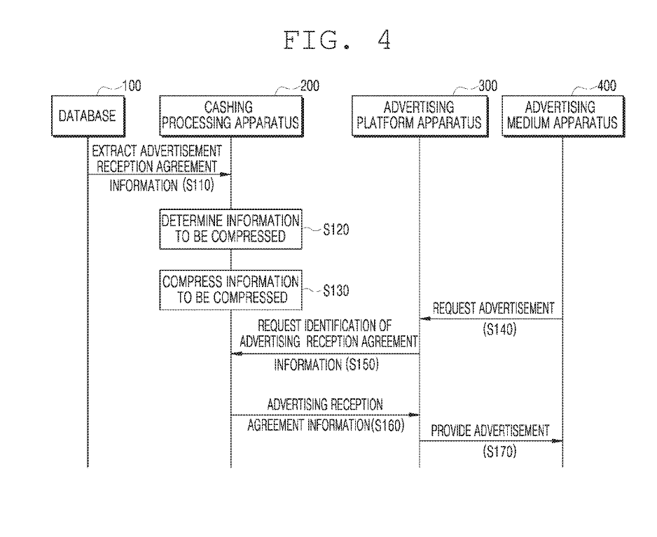

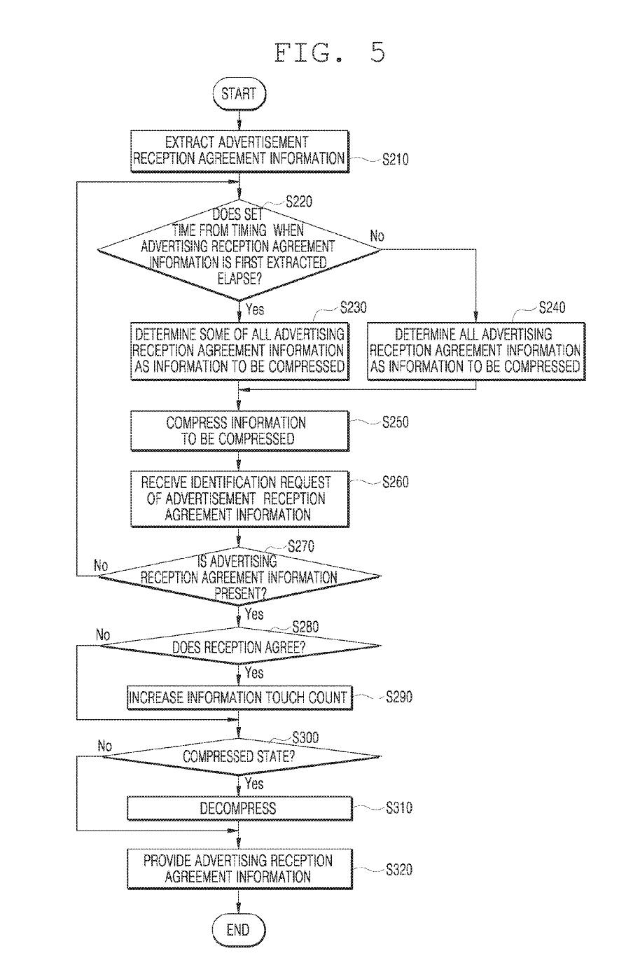

Hereinafter, an advertising service method according to an embodiment of the present invention will be described with reference to FIGS. 4 and 5. Here, for convenience of explanation, the configuration illustrated in FIGS. 1 to 3 as described above will be described by referring to the corresponding reference number.

First, an operation flow of the advertisement based cashing processing system according to an embodiment of the present invention will be described with reference to FIG. 4.

First, the cashing processing apparatus 200 extracts the advertisement reception agreement information stored in the database 100 and stores the extracted advertisement reception information in its own memory space (S110).

In this case, the cashing processing apparatus 200 may extract and store the advertisement reception agreement information stored in the database 100 in a lump at each period (for example: day unit) or individually extract and store the advertisement reception agreement information requested to be identified from the advertisement platform apparatus 300 from the database 100 regardless of the period.

Next, the cashing processing apparatus 200 determines at least part of all of the advertisement reception agreement information extracted from the database 100 as the information to be compressed (S120).

In this case, the cashing processing apparatus 200 determines all the advertisement reception agreement information extracted from the database 100 as the information to be compressed when the advertisement reception agreement information does not pass a set-up time (for example: four hours) from the first extracted timing since it means that the information identification count is not sufficiently accumulated and updated.

On the other hand, the cashing processing apparatus 200 chooses only some of the advertisement reception agreement information extracted from the database 100 and determines the chosen advertisement reception agreement information as the information to be compressed when the advertisement reception agreement information passes a set-up time (for example: four hours) from the first extracted timing since it means that the information identification count is sufficiently accumulated and updated.

Here, when only some of all the advertisement reception agreement information is determined as the information to be compressed, the cashing processing apparatus 200 determines the information to be compressed on the basis of the information identification count of all of the advertisement reception agreement information, respectively.

That is, the cashing processing apparatus 200 accumulates and sums all the advertisement reception agreement information in a rank of the most information identification count and when the accumulated and summed information identification count reaches a set ratio compared to all the information identification count, determines the rest advertisement reception agreement information which are not summed among all the advertisement reception agreement information as the information to be compressed.

Next, the cashing processing apparatus 200 may compress the advertisement reception agreement information determined as the information to be compressed among all the advertisement agreement information extracted and stored from the database 100 so that the advertisement platform apparatus 300 may identify the rest advertisement reception agreement information which is not compressed.

In this case, in compressing the advertisement reception agreement information, the cashing processing apparatus 200 compresses only ‘membership information’ requiring a storage space larger than that required for other information among the information included in the advertisement reception agreement information.

Next, if the identification of the advertisement reception agreement information is requested from the advertisement platform apparatus 300 receiving the advertising request from the advertisement medium apparatus 400, the cashing processing apparatus 200 extracts the corresponding advertisement reception agreement information stored in the memory space and transmits the extracted advertisement reception agreement information to the advertisement medium apparatus 400 (S140 to S170).

In this case, if it is checked that the advertisement reception does not agree (x) on the basis for the ‘agreement or not’ included in the corresponding advertisement reception agreement information, the casing processing apparatus 200 notifies the corresponding advertisement platform apparatus 300 of the checked information so that the advertisement platform apparatus 300 does not provide advertisement to the advertisement medium apparatus 100.

On the other hand, if it is checked that the advertisement reception agrees (o) on the basis of the ‘agreement or not’ included in the corresponding advertisement reception information, the cashing processing apparatus 200 once accumulates the information identification count and updates the accumulated information identification count.

Here, when the information identification count is accumulated and updated and then the compressed state of the corresponding advertisement reception agreement information, the casing processing apparatus 200 transmits the information identification count to the advertisement platform apparatus 300 after the decompression, so that the advertisement platform apparatus 300 provides advertisement to the advertisement medium apparatus 100.

Hereinafter, the operation of the cashing processing apparatus 200 according to the embodiment of the present invention will be described in more detail with reference to FIG. 5.

First, the extraction unit 210 extracts the advertisement reception agreement information stored in the database 100 and stores the extracted advertisement reception information in the storage unit 240 which is its own memory space (S210).

In this case, the extraction unit 210 may extract and store the advertisement reception agreement information stored in the database 100 in a lump at each period (for example: day unit) or individually extract and store the advertisement reception agreement information requested to be identified from the advertisement platform apparatus 300 from the database 100 regardless of the period.

Here, when the advertisement reception agreement information requested to be identified from the advertisement platform apparatus 300 is present in its own memory space in advance, there is no need to extract the advertisement reception agreement information from the database 100.

Next, to determine the information to be compressed, the determination unit 220 checks whether a set-up time (for example: four hours) from the time when the advertisement reception agreement information is first extracted from the database 100, that is, a start time of a current period elapses (S220).

In this case, the determination unit 220 chooses only some of the advertisement reception agreement information extracted from the database 100 and determines the chosen advertisement reception agreement information as the information to be compressed when the advertisement reception agreement information passes a set-up time (for example: four hours) from the first extracted timing since it means that the information identification count is sufficiently accumulated and updated (S230).

Here, when only some of all the advertisement reception agreement information is determined as the information to be compressed, the cashing processing apparatus 200 determines the information to be compressed on the basis of the information identification count of all of the advertisement reception agreement information, respectively.

That is, the determination unit 220 accumulates and sums all the advertisement reception agreement information in a rank of the most information identification count and when the accumulated and summed information identification count reaches a set ratio compared to all the information identification count, determines the rest advertisement reception agreement information which are not summed among all the advertisement reception agreement information as the information to be compressed.

Therefore, the determination unit 220 determines the advertising reception agreement information having the reduced information identification count as the information to be compressed to secure the memory space and maintains the storage stat in the non-compressed state in the case of the advertising reception agreement information having the increased information identification count, such that the identification may be performed without the separate decompression procedure.

Meanwhile, the information to be compressed may be determined on the basis of the number of all the advertising reception agreement information, that is, the number of users determining whether the advertising reception agrees.

That is, the determination unit 220 excludes all the advertising reception agreement information in the rank of the most information identification count and determines the rest advertising reception agreement information which is not excluded from all the advertising reception agreement information as the information to be compressed when the number of excluded advertising reception agreement information reaches the number of all the advertising reception agreement information as much as the set ratio.

A series of operations of the determination unit 220 for determining the information to be compressed as described above may be repeated whenever the advertising reception agreement information is extracted from the database 100 or the advertising platform apparatus 300 identifies the advertising reception agreement information.

Meanwhile, the determination unit 220 determines all the advertisement reception agreement information extracted from the database 100 as the information to be compressed when the advertisement reception agreement information does not pass a set-up time (for example: four hours) from the first extracted timing since it means that the information identification count is not sufficiently accumulated and updated (S240).

Next, the compression unit 230 may compress the advertisement reception agreement information determined as the information to be compressed among all the advertisement agreement information extracted and stored from the database 100 so that the advertisement platform apparatus may identify the rest advertisement reception agreement information which is not compressed (S250).

In this case, in compressing the advertisement reception agreement information, the compression unit 230 compresses only ‘membership information’ requiring a storage space larger than that required for other information among the information included in the advertisement reception agreement information.

The rest information included in the advertising reception agreement information such as ‘rank’ depending on the information identification count, ‘information identification count’, ‘agreement or not’, and ‘agreement information change time’ is maintained in the non-compressed state since the substantially small storage space is required.

Next, if the identification of the advertising reception agreement information is requested from the advertising platform apparatus 300 receiving the advertising request from the advertising medium apparatus 400, the identification unit 250 checks whether the corresponding advertising reception agreement information is stored (S260 and S270).

In this case, the identification unit 250 checks whether the advertising reception agrees on the basis of the ‘agreement or not’ included in the corresponding advertising reception agreement information if the advertising reception agreement information receiving the identification request from the advertising platform apparatus 300 is stored and notifies the corresponding advertising platform apparatus 300 of the checked information not to allow the advertising platform apparatus 300 to provide advertisement to the advertising medium apparatus 10 if it is checked that the advertising reception does not agree (x) (S280).

In this case, if it is checked that the advertisement reception agrees (o) on the basis of the ‘agreement or not’ included in the corresponding advertisement reception information, the identification unit 250 once accumulates the information identification count and updates the accumulated information identification count (S290).

Next, when the information identification count is accumulated and updated and then the compressed state of the corresponding advertisement reception agreement information, the identification unit 250 transmits the information identification count to the advertisement platform apparatus 300 after the decompression, so that the advertisement platform apparatus 300 provides advertisement to the advertisement medium apparatus 100 (S300 to S320).

Meanwhile, the identification unit 250 allows the extraction unit 210 to extract the corresponding advertising reception agreement information from the database 100 only when the advertisement reception agreement information receiving the identification request from the advertising platform apparatus 300 is not stored to be able to transmit the extracted advertising reception agreement information to the advertising platform apparatus 300.

In this case, the advertisement reception agreement information extracted from the database 100 may preferentially update only the information identification count and then may be transmitted to the advertising platform apparatus 300 and may be reflected as a candidate for determining the information to be compressed after the transmission.

As described above, according to the advertising based cashing processing method in accordance with the embodiment of the present invention, to check whether the advertising requester may receive advertisement, the casing processing apparatus 200 is configured to compress at least part of all the advertising reception agreement information extracted from the database 100 to allow the advertising medium apparatus 300 to identify the advertising medium apparatus 300 to identify the advertising reception agreement information to thereby minimize the access to the database 10 depending on the identification of the advertising reception agreement information, thereby preventing disorders from occurring due to the excessive traffic depending on the frequent access to the database 100.

Meanwhile, the steps of the method or the algorithm described in connection with the embodiments proposed herein may be directly implemented in hardware or implemented in a program command form that may be executed by various computer means to be recorded in a computer-readable medium. The computer-readable recording medium may include a program command, a data file, a data structure or the like, alone or a combination thereof. The program commands recorded in the computer-readable recording medium may be especially designed and constituted for the present invention or be known to those skilled in a field of computer software. An example of the computer readable recording medium may include magnetic media such as hard disk, floppy disk, magnetic tape, and the like, optical media such as CD-ROM, DVD, and the like, magneto-optical media such as floppy disk, and hardware devices specially configured to store and perform program commands such as ROM, RAM, flash memory, and the like. Examples of the program commands may include a high-level language code capable of being executed by a computer using an interpreter, or the like, as well as a machine language code made by a compiler. The hardware device may be constituted to be operated as one more software modules in order to perform the action according to the present invention, and vice versa.

Although the present invention is described in detail with reference to the preferred embodiments, the present invention is not limited to the foregoing embodiments. A person having ordinary skill in the art to which the present invention pertains may variously change or modify the present invention without deviating from the scope of the present invention.

### INDUSTRIAL APPLICABILITY

According to the advertisement based caching processing system, the method therefor, and the apparatus applied thereto of the present invention, at least part of all the advertising reception agreement information extracted from the database may be identified in the compressed state to check whether the advertising requester may receive advertisement and therefore the present invention jumps over the limit of the existing technology, such that they may have the sufficient possibility of marketing or business of the applied apparatus as well as the use of the related technology and may be clearly practiced realistically. As a result, the present invention has industrial applicability.

1. A cashing processing apparatus, comprising:
an extraction unit configured to extract advertisement reception agreement information from a database, advertisement reception agreement information being required to be identified from an advertising platform apparatus;
a determination unit configured to determine at least part of all the advertisement reception agreement information extracted from the database as information to be compressed; and
a compression unit configured to compress the advertisement reception agreement information determined as the information to be compressed to allow the advertising platform apparatus to identify the compressed advertising reception agreement information in a compressed state.

2. The cashing processing apparatus of claim 1, wherein the information to be compressed is determined on the basis of all the information identification count obtained by summing information identification count for each of all the advertising reception agreement information, and
the determination unit accumulates and sums the information identification count in a rank of the most information identification count all the advertising reception agreement information and determine the rest advertising reception agreement information of which the information identification count is not summed among all the advertising reception agreement information as the information to be compressed when the accumulated and summed information identification count reaches a set ratio for all the information identification count.

3. The cashing processing apparatus of claim 1, wherein the information to be compressed is determined on the basis of the number of all the advertising reception agreement information, and
the determination unit excludes the advertising reception agreement information in the rank of the most information identification count and determines the rest advertising reception agreement information which is not excluded from all the advertising reception agreement information as the information to be compressed when the number of excluded advertising reception agreement information reaches the number of all the advertising reception agreement information as much as the set ratio.

4. The cashing processing apparatus of claim 1, wherein the information to be compressed is determined on the basis of whether a set-up time from timing when the advertisement reception agreement information is first extracted from the database elapses, and
the determination unit determines all the advertising reception agreement information as the information to be compressed when the set time from timing when the advertising reception agreement information is first extracted from the database does not elapse and determines only part of all the advertising reception information as the information to be compressed when the set time from timing when the advertising reception agreement information is first extracted from the database elapses.

5. An advertising based cashing processing method, comprising:
extracting, by a cashing processing apparatus, advertisement reception agreement information from a database, advertisement reception agreement information being required to be identified from an advertising platform apparatus;
sorting, by the cashing processing apparatus, at least part of all the advertisement reception agreement information extracted from the database as information to be compressed;
compressing, by the cashing processing apparatus, the advertising reception agreement information determined as the information to be compressed; and
identifying, by the advertising platform apparatus, the compressed advertising reception agreement information in a compressed state.

6. A method for operating a cashing processing apparatus, comprising:
extracting advertisement reception agreement information a database, advertisement reception agreement information being required to be identified from an advertising platform apparatus;
determining at least part of all the advertisement reception agreement information extracted from the database as information to be compressed; and
compressing the advertisement reception agreement information determined as the information to be compressed to allow the advertising platform apparatus to identify the compressed advertising reception agreement information in a compressed state.

7. The method of claim 6, wherein the information to be compressed is determined on the basis of all the information identification count obtained by summing information identification count for each of all the advertising reception agreement information, and
the determining comprises:
accumulating and summing the information identification count in a rank of the most information identification count all the advertising reception agreement information and
determining the rest advertising reception agreement information of which the information identification count is not summed among all the advertising reception agreement information as the information to be compressed when the accumulated and summed information identification count reaches a set ratio for all the information identification count.

8. The method of claim 6, wherein the information to be compressed is determined on the basis of the number of all the advertising reception agreement information, and
the determining comprises:
excluding the advertising reception agreement information in the rank of the most information identification count and
determining the rest advertising reception agreement information which is not excluded from all the advertising reception agreement information as the information to be compressed when the number of excluded advertising reception agreement information reaches the number of all the advertising reception agreement information as much as the set ratio.

9. The method of claim 6, wherein the information to be compressed is determined on the basis of whether a set-up time from timing when the advertisement reception agreement information is first extracted from the database elapses, and
the determining comprises:
determining all the advertising reception agreement information as the information to be compressed when the set time from timing when the advertising reception agreement information is first extracted from the database does not elapse and determining only part of all the advertising reception information as the information to be compressed when the set time from timing when the advertising reception agreement information is first extracted from the database elapses.
